(19) United States
(12) Patent Application Publication
(10) Pub. No.: US 2008/0317961 A1
(43) Pub. Date: Dec. 25, 2008

(54) Method for manufacturing resin-coated carbon nanomaterial and method for manufacturing carbon nanocomposite resin molded article

(75) Inventors: Makoto Kozuka, Hanishina-gun (JP); Koji Kobayashi, Hanishina-gun (JP); Yoshihiko Takahashi, Hanishina-gun (JP)

Correspondence Address: BRUCE L. ADAMS, ESQ.;ADAMS & WILKS, SUITE 1231, 17 BATTERY PLACE, NEW YORK, NY, 10004, US

(73) Assignee: NISSEI PLASTIC INDUSTRIAL CO., LTD.

(21) Appl. No.: 12/214,494

(22) Filed: Jun. 19, 2008

(30) Foreign Application Priority Data
Jun. 22, 2007 (JP) 2007-165363

(51) Int. Cl. B05D 3/00

(52) U.S. Cl. 427/385.5; 977/842

(57) ABSTRACT

A method of manufacturing a carbon nanomaterial coated with a resin is disclosed. A resin material and organic solvent are mixed to obtain a resin dispersion solution. A carbon nanomaterial is added to the resin dispersion solution, and mixed therewith to sufficiently disperse the carbon nanomaterial. Water is added to the carbon nanomaterial/resin dispersion solution to yield an aqueous solution. THF is removed with the water when the aqueous solution is filtered with a filter paper. The remaining article is dried to yield a resin-coated carbon nanomaterial.

### FIELD OF THE INVENTION

The present invention relates to a technique for mixing a resin material and carbon nanomaterial.

### BACKGROUND OF THE INVENTION

In recent years, techniques for mixing special carbon fibers known as carbon nanomaterials with a plastic material to produce an electroconductive plastic, or with molten metal to produce fiber reinforced metal have been receiving attention.

FIG. 8 hereof shows a model of a carbon nanofiber. A carbon nanofiber 110, which is one type of carbon nanomaterial, has a configuration in which a sheet composed of carbon atoms arranged in a hexagonal reticulated shape is cylindrical wrapped, and has a diameter D of 1.0 nm (nanometers) to 150 nm. The name “carbon nanomaterial” derives its name from the fact that material is structured on a nanoscale. A length L is several μm to 100 μm.

A material in which carbon atoms are aligned in a cubic lattice pattern is diamond, and the diamond is very hard material. The carbon nanofiber 110 has considerable mechanical strength because it possesses a regular crystal structure similar to diamond. Also, carbon conducts electricity well and can therefore be used in electrodes or the like.

However, carbon nanomaterials are ultrafine, as stated above, and are accordingly difficult to handle. This is due to their characteristics, which, when compared with those of carbon powders on a micron scale, resulting in the materials aggregating more readily, and dispersing less readily.

In view of the above, the present inventor proposed a technique for accelerating the mixing of a resin material with carbon nanomaterial in Japanese Patent Application Laid-Open Publication No. 2005-298553 (JP 2005-298553 A). FIG. 9 hereof shows the technique of JP 2005-298553 A.

As shown in FIG. 9, in step (abbreviated hereinbelow as ST) 101, first, prescribed quantities of resin material and carbon nanomaterial are prepared. The resin material is preferably a powder, particles, or another form having a large surface area.

In ST102, the resin material and carbon nanomaterial are placed in a mixing container and mixed while a temperature at which the entire surface area of the resin material softens is maintained. A mixture of the resin material and carbon nanomaterial can be obtained thereby.

In relation to the temperature at which the entire surface area of the resin material softens, the melting temperature is 160 to 170° C. when the resin material is polypropylene, and the heating temperature is set to 140 to 160° C. The melting temperature is 253 to 265° C. when the resin material is polyethylene terephthalate (PET), and the heating temperature is preferably set to 200 to 210° C.

FIG. 10 shows a schematic diagram of a mixture obtained using the method of the present invention. A mixture 110 has innumerable carbon nanomaterials 112 deposited on the surface of a resin material 111.

Since the carbon nanomaterials 112 are deposited at the periphery of the resin material 111, the carbon nanomaterials 112 tend not to aggregate together, and as a result, the carbon nanomaterials 112 can be uniformly dispersed in the resin material.

A uniform improvement in strength is observed when injection molding is carried out using such a mixture 110 to obtain a resin molded article. However, the range in the improvement in strength is not as large as expected. The reason is that the mixture 110 is placed in a heating pipe of the injection-molding machine, and a portion of the carbon nanomaterials 112 that are deposited on the resin material 111 fall off in the kneading stage (initial stage of plasticization and measurement steps). Also, the carbon nanomaterials 112 that have fallen off are thought to have aggregated before being dispersed in the resin.

In view of the above, there is a need for a mixing technique that replaces conventional mixing techniques (heating and mixing technique, hereinbelow referred to as heating method).

### SUMMARY OF THE INVENTION

An object of the present invention is to provide a novel technique for mixing a resin material and a carbon nanomaterial that can further increase the strength of a molded article.

According to one aspect of the present invention, there is provided a method for manufacturing resin-coated carbon nanomaterial, which method comprises the steps of: preparing an organic solvent having tetrahydrofuran as a main ingredient, a resin material dissolved in the organic solvent, a carbon nanomaterial, and water; mixing the organic solvent and the resin material, thereby dissolving the resin material in the organic solvent and obtaining a resin dispersion solution; adding the carbon nanomaterial to the resulting resin dispersion solution and stirring the solution in order to obtain a carbon nanomaterial/resin dispersion solution; forming an aqueous solvent phase wherein water is added to the resulting carbon nanomaterial/resin dispersion solution and the organic solvent is converted to an aqueous phase; and drying the aqueous phase solution so as to remove the organic solvent in order to obtain a resin-coated carbon nanomaterial.

The manufacturing method according to the present invention was thus perfected with the aim of coating the carbon nanomaterial with the resin material. The resin material on the surface is a barrier that hinders carbon nanomaterials from coming into contact and aggregating. For this reason, the resin material as a coating material must be made into liquid. A solvent is necessary for forming a liquid, but in the present invention, an organic solvent in which tetrahydrofuran is a main ingredient was adopted with consideration given to two points, i.e., toxicity and post-processing. An organic solvent in which tetrahydrofuran is a main ingredient has relatively low toxicity. By being mixed with water, the organic solvent can be transferred to an aqueous phase, and can be readily removed.

The resin material is liquefied using an organic solvent in which tetrahydrofuran is a main ingredient, and the carbon nanomaterial is admixed with the liquid. The carbon nanomaterial is thereby coated with the resin material. Afterwards, the organic solvent is removed using water, and the carbon nanomaterial coated with resin can be obtained by drying. A high-strength molded article can be obtained using the resin-coated carbon nanomaterial when injection molding is performed.

In the stirring step, stirring is preferably performed by mechanical stirring. In mechanical stirring, a solution is stirred with the aid of a rod or blade. Ultrasonic stirring is another typical stirring method. Ultrasonic stirring is much more powerful than mechanical stirring, will reduce the stirring time. However, experimental results confirmed a phenomenon in which certain resins lose their strength as a result of ultrasonic stirring. This is presumably because the resin is degraded by ultrasonic waves, and additives readily come out of the resin. In this regard, when mechanical stirring is used, resin-coated carbon nanomaterials can be stirred without being so degraded.

The resin material preferably includes at least one resin selected from polycarbonate resin, polystyrene resin, and polymethyl methacrylate resin. Polycarbonate resin, polystyrene resin, and polymethyl methacrylate resin are all readily obtained and inexpensive, and are materials that are soluble in organic solvents having tetrahydrofuran as a main ingredient.

The percentage of carbon nanomaterial is preferably 3 to 20 mass % of the carbon resin-coated nanomaterial. High strength can be obtained when the percentage is 3 mass % or more. On the other hand, when the percentage exceeds 20 mass %, the material disassociates without reaching a maximum tensile yield point, and the strength is reduced. Accordingly, the addition of carbon nanomaterial is set to 3 to 20 mass %.

The carbon nanomaterial is preferably an ungraphitized carbon nanomaterial; i.e., one that has not been subjected to a graphitization treatment. Ungraphitized carbon nanomaterials have a surface that is rougher than graphitized carbon nanomaterials, and therefore more readily intermix with resin materials. As a result, improved strength can be expected.

According to another aspect of the present invention, there is provided a method for manufacturing a carbon nanocomposite resin molded article, which method comprises the steps of: preparing an organic solvent having tetrahydrofuran as a main ingredient, a resin material dissolved in the organic solvent, a carbon nanomaterial, and water; mixing the organic solvent and the resin material, thereby dissolving the resin material in the organic solvent and obtaining a resin dispersion solution; adding the carbon nanomaterial to the resulting resin dispersion solution and stirring the solution in order to obtain a carbon nanomaterial/resin dispersion solution; forming an aqueous solvent phase wherein water is added to the resulting carbon nanomaterial/resin dispersion solution and the organic solvent is converted to an aqueous phase; drying the aqueous phase solution so as to remove the organic solvent in order to obtain a resin-coated carbon nanomaterial; preparing a carbon nanomaterial coated with the resulting resin; and injection-molding the resin-coated carbon nanomaterial, thereby obtaining a carbon nanocomposite resin molded article.

In this manner, the dispersibility of the carbon nanomaterial can be maintained and a high strength resin-molded article can be manufactured because a resin-coated carbon nanomaterial is used in injection molding.

### BRIEF DESCRIPTION OF THE DRAWINGS

Certain preferred embodiments of the present invention will be described in detail below, by way of example only, with reference to the accompanying drawings, in which:

FIG. 1 illustrates steps in a manufacturing method according to the present invention;

FIG. 2 is a flowchart of Embodiments 1 to 4;

FIG. 3 is a flowchart of Comparative Examples 1 and 2;

FIG. 4 is a graph showing a correlation between the tensile strength and the percentage of carbon nanomaterials added;

FIG. 5 is a flowchart of Embodiment 5;

FIG. 6 is a flowchart of Embodiment 6;

FIG. 7 is a graph showing a correlation between the tensile strength and percentage of carbon nanomaterials added;

FIG. 8 is a model view of conventional carbon nanofibers;

FIG. 9 is a flowchart of conventional manufacturing; and

FIG. 10 is a schematic view of a mixture obtained using the method of the present invention.

### DETAILED DESCRIPTION OF THE PREFERRED EMBODIMENTS

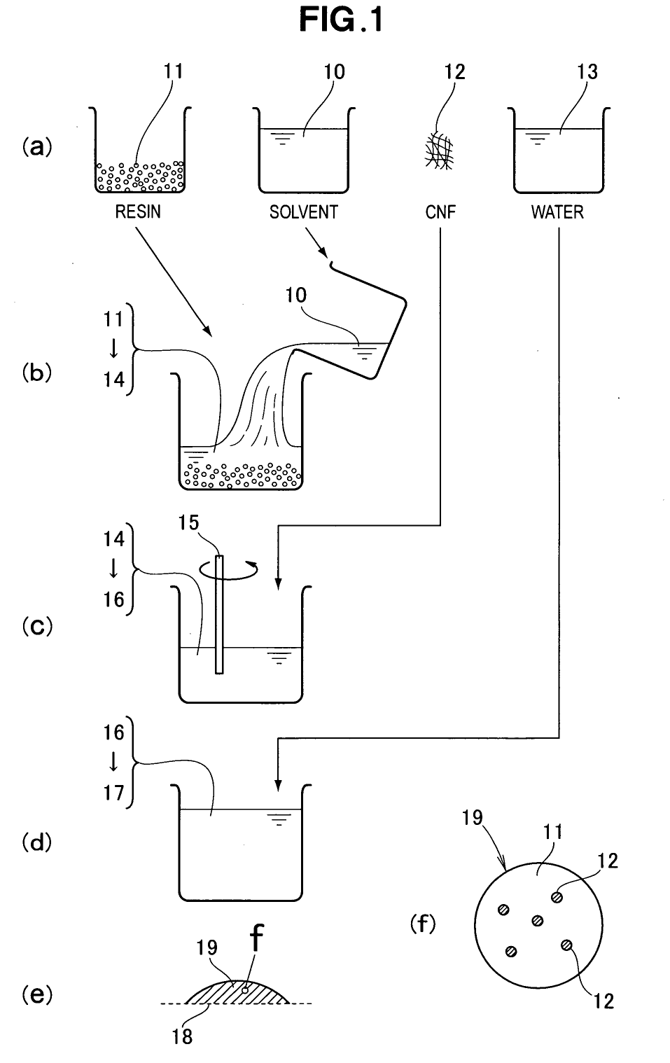

An organic solvent 10 in which tetrahydrofuran (THF) is a main ingredient, a resin material 11 to be dissolved in the organic solvent 10, a suitable quantity of a carbon nanomaterial 12, and water 13 are prepared, as shown in FIG. 1(a).

The resin material 11 may be any type as long as the resin dissolves in THF, but a polycarbonate resin, a polystyrene resin, a polymethyl methacrylate resin, and a modified polyphenylene ether resin are preferred because they are readily and inexpensively obtained. The resin material may be one in which two or more resin materials are mixed.

A suitable quantity of the carbon nanomaterial 12 is such that the sum of the amount thereof and the resin material 11 is 3 to 20 mass %.

Next, the resin material 11 and the organic solvent 10 are mixed and the resin material 11 is dissolved in the organic solvent 10 to yield a resin dispersion solution 14, as shown in FIG. 1(b). The mixing may be performed by pouring the organic solvent 10 into the resin material 11 or by introducing the resin material 11 into the organic solvent 10.

Next, the carbon nanomaterial 12 prepared in FIG. 1(a) is added to the resin dispersion solution 14, as shown in FIG. 1(c). The carbon nanomaterial 12 is then adequately stirred using a stirring rod 15 so as to be dispersed. A carbon nanomaterial/resin dispersion solution 16 can be obtained thereby. The stirring rod 15 may be a stirring blade.

At this point, the THF is no longer required. Therefore, a sufficient amount of water 13 is added to the carbon nanomaterial/resin dispersion solution 16 to form an aqueous solution 17, as shown in FIG. 1(d). At this point, the THF is converted into an aqueous phase.

The aqueous solution 17 is filtered using a filter paper 18, as shown in FIG. 1(e). The THF is thereby removed along with the water. The remaining THF can be removed by drying. A resin-coated carbon nanomaterial 19 is obtained as a result of drying.

FIG. 1(f) is an enlargement of part F in FIG. 1(e). The resin-coated carbon nanomaterial 19 is the carbon nanomaterial 12 coated by a large quantity of the resin material 11.

In other words, the present invention is a method of manufacturing a resin-coated carbon nanomaterial, comprising the steps of: preparing an organic solvent 10 having tetrahydrofuran (THF) as a main ingredient, a resin material 11 dissolved in the organic solvent, a carbon nanomaterial 12, and water 13, as shown in FIG. 1(a); mixing the organic solvent 10 and the resin material 11, thereby dissolving the resin material in the organic solvent and obtaining a resin dispersion solution 14, as shown in FIG. 1(b); adding the carbon nanomaterial 12 to the resulting resin dispersion solution 14, and stirring the solution to obtain a carbon nanomaterial/resin dispersion solution 16, as shown in FIG. 1(c); forming an aqueous solvent phase wherein water 13 is added to the resulting carbon nanomaterial/resin dispersion solution 16 and the organic solvent is converted to an aqueous phase, as shown in FIG. 1(d); and drying a resulting aqueous phase solution 17 so as to remove the organic solvent in order to obtain a resin-coated carbon nanomaterial 19, as shown in FIG. 1(e).

The organic solvent in which tetrahydrofuran is a main ingredient has low toxicity. The organic solvent can be changed to an aqueous phase by being mixed with water, and can be readily removed.

The resin material is made into a liquid by using an organic solvent in which tetrahydrofuran is a main ingredient, as described above, and the carbon nanomaterials are admixed into this solution. The carbon nanomaterials are thereby coated with the resin material. Afterwards, the organic solvent is removed using water and the carbon nanomaterials coated with the resin materials can be obtained by drying.

An experiment was performed using specific resin materials (polycarbonate resin, polystyrene resin, and modified polyphenylene ether resin) and the superiority of the method of manufacturing of the present invention was confirmed. The details of the experiment will be described next.

### EXPERIMENTAL EXAMPLES

Experimental examples according to the present invention are described below. The experimental examples are not provided by way of limitation to the present invention.

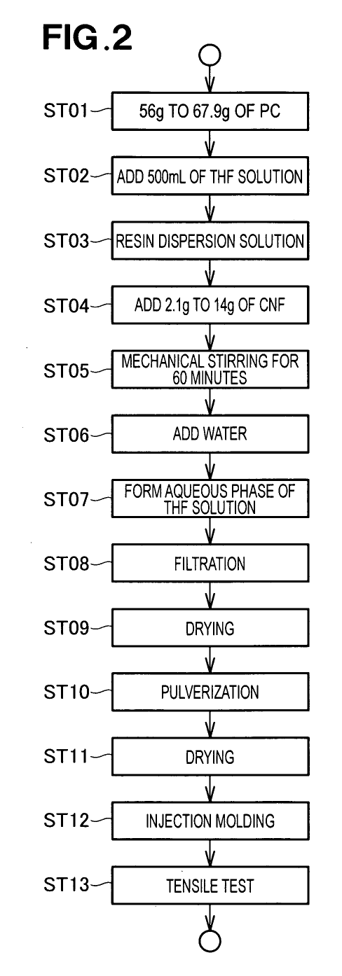

FIG. 2 is a flowchart of Embodiments 1 to 4. First, 56 to 67.9 g of PC (polycarbonate resin) was prepared (ST01), 500 mL of a THF solution was introduced into the resin (ST02), and a resin dispersion solution was obtained (ST03). Next, 2.1 to 14 g of a CNF (carbon nanomaterial) was introduced into the resin dispersion solution (ST04), the solution was mechanically mixed for 60 minutes (ST05), water was then added (ST06), and the THF solution was converted to an aqueous phase (ST07). The mixture was filtered (ST08) and dried (ST09) to obtain clumps. The clumps were pulverized to a size suitable for used as an injection molding material (ST10) and further dried (ST11). The injection molding material of suitable size was fed to an injection-molding machine, and injection molding was performed (ST12). The resulting resin-molded article was positioned in a tension testing machine, and the tensile strength was measured (ST13).

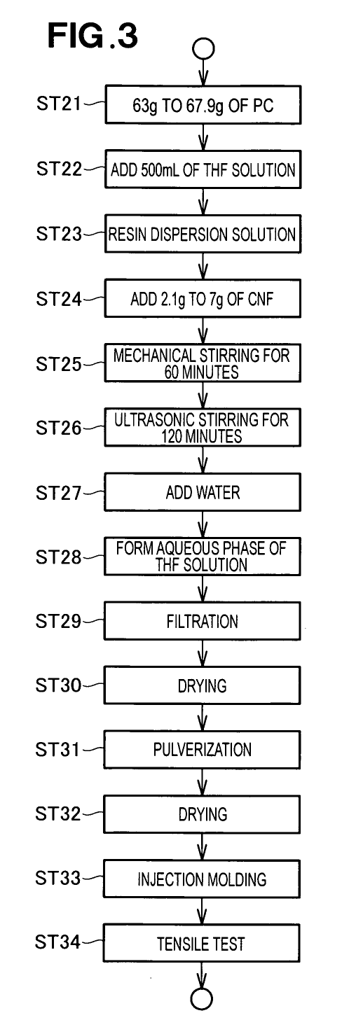

FIG. 3 is a flowchart of Comparative Examples 1 and 2, and ultrasonic stirring (ST26) is added between ST05 and ST06 of FIG. 2. The other steps are the same as FIG. 2. However, the step numbers (ST) have been renumbered and the description is repeated.

In other words, 63 to 67.9 g of PC (polycarbonate resin) was prepared (ST21), 500 mL of THF solution was added to the resin (ST22), and a resin dispersion solution was obtained (ST23). Next, 2.1 to 7 g of CNF (carbon nanomaterial) was added to the resin dispersion solution (ST24), the solution was mechanically mixed for 60 minutes (ST25), and ultrasonically stirred for an additional 120 minutes (ST26).

Next, water was added (ST27), and the THF solution was converted to an aqueous phase (ST28). The mixture was filtered (ST29) and dried (ST30) to obtain clumps. The clumps were pulverized to a size suitable for an injection molding material (ST31) and further dried (ST32). The injection molding material of suitable size was fed to an injection-molding machine, and injection molding was performed (ST33). The resulting resin-molded article was positioned in a tension testing machine, and the tensile strength was measured (ST34).

### Comparative Examples 3 to 5

For further comparison, molding materials were manufactured by conventional techniques (FIG. 9), resin-molded articles were manufactured using these materials, the resulting resin injection molded articles were placed in a tension testing machine, and the tensile strength was measured.

The details and results of Embodiments 1 to 3 and Comparative Examples 1 to 5 are summarized in TABLE 1.

TABLE 1

Process

| | Material P̅C̅ T̅H̅F̅ C̅N̅F̅ | Flow | Heating | UltrasonicStirring | $\frac{CNF}{PC + CNF}$ | TensileStrength |
|---|---|---|---|---|---|---|
| Embodiment 1 | 67.9 g 500 mL 2.1 g | FIG. 2 | | | 3% | 67.3 MPa |
| Embodiment 2 | 66.5 g 500 mL 3.5 g | FIG. 2 | | | 5% | 70.7 MPa |
| Embodiment 3 | 63 g 500 mL 7 g | FIG. 2 | | | 10% | 72.3 MPa |
| Embodiment 4 | 56 g 500 mL 14 g | FIG. 2 | | | 20% | 74.8 MPa |
| Comparative | | | | | | |
| Example 1 | 66.5 g 500 mL 3.5 g | FIG. 3 | | ◯ | 5% | 64.7 MPa |
| Comparative | 63 g 500 mL 7 g | FIG. 3 | | ◯ | 10% | 66.0 MPa |
| Example 2 | | | | | | |
| Comparative | 66.5 g 3.5 g | FIG. 9 | ◯ | | 5% | 64.4 MPa |
| Example 3 | | | | | | |
| Comparative | 64.7 g 5.3 g | FIG. 9 | ◯ | | 7.5% | 65.9 MPa |
| Example 4 | | | | | | |
| Comparative | 63 g 7 g | FIG. 9 | ◯ | | 10% | 64.7 MPa |
| Example 5 | | | | | | |

In Embodiment 1, 67.9 g of PC (polycarbonate), 500 mL of THF solution, and 2.1 g of CNF (carbon nanomaterial) were prepared and processed in accordance with the procedure of FIG. 2. The percentage of carbon nanomaterial added (calculated using CNF/(PC+CNF); same hereinbelow) was 3%. The tensile strength of the resulting resin-molded article was 67.3 MPa.

In Embodiment 2, the percentage of carbon nanomaterial added was 5% in contrast to Embodiment 1. The tensile strength of the resulting resin-molded article was 70.7 MPa.

In Embodiment 3, the percentage of carbon nanomaterial added was 10% in contrast to Embodiment 1. The tensile strength of the resulting resin-molded article was 72.3 MPa.

In Embodiment 4, the percentage of carbon nanomaterial added was 20% in contrast to Embodiment 1. The tensile strength of the resulting resin-molded article was 74.8 MPa.

In Comparative Example 1, ultrasonic stirring was added to Embodiment 2.

In other words, in Comparative Example 1, 66.5 g of polycarbonate, 500 mL of THF solution, and 3.5 g of carbon nanomaterial were prepared and processed in accordance with the procedure of FIG. 3. The percentage of carbon nanomaterial added was 5%. The tensile strength of the resulting resin-molded article was 64.7 MPa.

In Comparative Example 2, the percentage of carbon nanomaterial added was 10%, in contrast to Embodiment 1. The tensile strength of the resulting resin molded article was 66.0 MPa.

Comparative Examples 3 to 5 were produced using a conventional heating method.

In other words, in Comparative Example 3, 66.5 g of polycarbonate, 3.5 g of carbon nanomaterial were prepared and processed in accordance with the procedure of FIG. 9. The percentage of carbon nanomaterial added was 5%. The tensile strength of the resulting resin molded article was 64.4 MPa.

In Comparative Example 4, the percentage of carbon nanomaterial added was 7.5%, in contrast to Comparative Example 3. The tensile strength of the resulting resin molded article was 65.9 MPa.

In Comparative Example 5, the percentage of carbon nanomaterial added was 10%, in contrast to Embodiment 3. The tensile strength of the resulting resin molded article was 64.7 MPa.

The results of the chart were graphed.

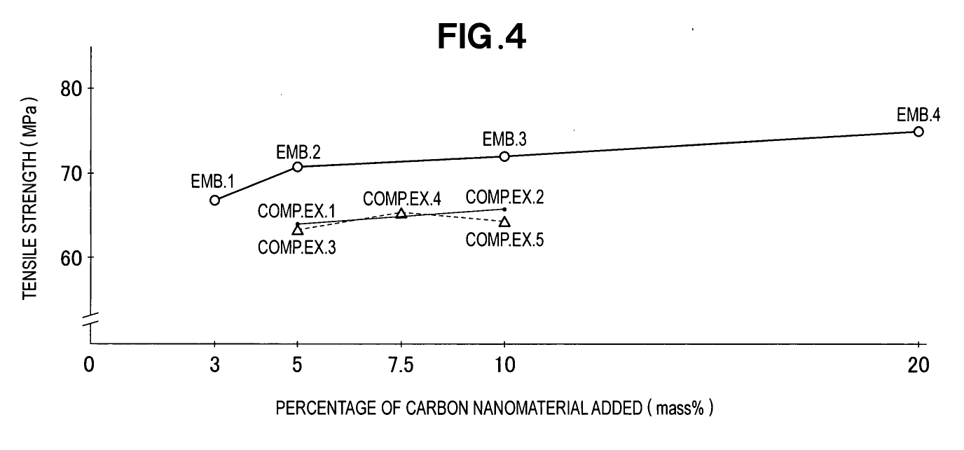

FIG. 4 is a graph showing a correlation between the percentage of carbon nanomaterial added and the tensile strength. When Embodiments 1 to 4, Comparative Examples 1 and 2, and Comparative Examples 3 to 5 were plotted, Embodiments 1 to 4 were found to have a tensile strength that was about 10% higher than that of Comparative Examples 1 to 5.

First, the Embodiments 1 to 4 were superior to Comparative Examples 3 to 5, which were based on a conventional heating method, which confirmed the superiority of carbon nanomaterials coated with a resin material.

On the other hand, since Comparative Examples 1 and 2, in which ultrasonic stirring was used to accelerate stirring, produced results similar to Comparative Examples 3 to 5, it was thought that the resin decomposed when ultrasonic stirring was performed and additives readily came out of the resin.

Next, an experiment (Embodiment 5) for the case in which polystyrene resin was used as the resin material will be described.

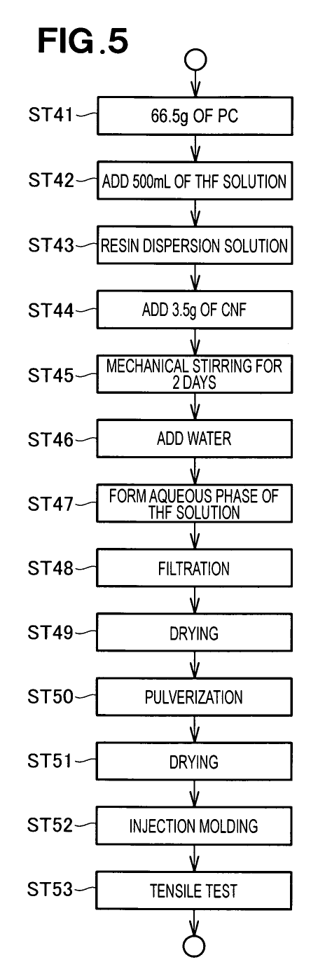

FIG. 5 is a flowchart of Embodiment 5, in which 66.5 g of PS (polystyrene resin) was prepared, (ST41), 500 mL of THF solution was added to the resin (ST42), and a resin dispersion solution was obtained (ST43). Next, 3.5 g of CNF (carbon nanomaterial) was added to the resin dispersion solution (ST44), the solution was mechanically mixed for 60 minutes (ST45), water was then added (ST46), and the THF solution entered an aqueous phase (ST47). The mixture was filtered (ST48) and dried (ST49) to obtain clumps. The clumps were pulverized to a size suitable for
an injection molding material (ST50) and further dried (ST51). The injection molding material of suitable size was fed to an injection-molding machine and injection molding was performed (ST52). A resulting resin-molded article was placed in a tension testing machine and the tensile strength was measured (ST53).

TABLE 2

| | Material | | | Process | | Tensile |
|---|---|---|---|---|---|---|
| | PS | THF | CNF | Flow | Heating | Strength |
| Embodiment | 66.5 g | 500 mL | 3.5 g | FIG. 5 | | 45 MPa |
| 5 | | | | | | |
| Comparative | 66.5 g | | 3.5 g | FIG. 9 | ∘ | 42.4 MPa |
| Example 5 | | | | | | |

In Embodiment 5, 66.5 g of PS (polystyrene resin), 500 mL of THF solution, and 3.5 g of carbon nanomaterial were prepared and processed in accordance with the procedure of FIG. 5. The tensile strength of the resulting resin-molded article was 45 MPa.

In Comparative Example 6, 66.5 g of PS (polystyrene resin) and 3.5 g of carbon nanomaterial were prepared and processed in accordance with the procedure of FIG. 9. The tensile strength of the resulting resin-molded article was 42.4 MPa.

Embodiment 5 had a 6% greater tensile strength than that of Comparative Example 6 using the calculation 45 MPa/42.4 MPa=1.06.

Next, an experiment (Embodiment 6) for the case in which modified polyphenyl ether resin (polymer alloy of PS and PPE) was used as the resin material will be described.

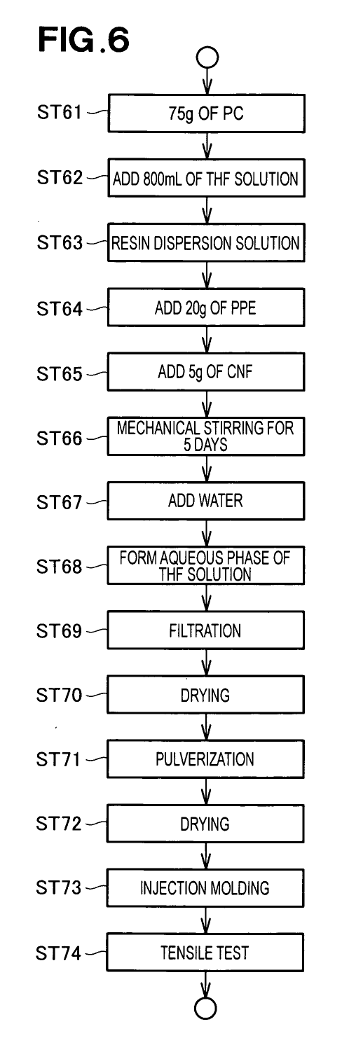

FIG. 6 is a flowchart of Embodiment 6.75 g of PS (polystyrene resin) was prepared (ST61), 800 mL of THF solution was added to the resin (ST62), and a resin dispersion solution was obtained (ST63). Next, 20 g of PPE (polyphenyl ether resin) was added to the resin dispersion solution (ST64), 5 g of CNF (carbon nanomaterial) was further added (ST65), the solution was mechanically mixed for 5 days (ST66), water was then added (ST67), and the THF solution entered an aqueous phase (ST68). The mixture was filtered (ST69) and dried (ST70) to obtain clumps. The clumps were pulverized to a size suitable for an injection molding material (ST71) and further dried (ST72). The injection molding material of suitable size was fed to an injection-molding machine and injection molding was performed (ST73). The resulting resin-molded article was placed in a tension testing machine and the tensile strength was measured (ST74).

TABLE 3

| | Material | | | | Process | | Tensile |
|---|---|---|---|---|---|---|---|
| | PS | PPE | THF | CNF | Flow | Heating | Strength |
| Embodiment | 75 g | 20 g | 500 mL | 5 g | FIG. 6 | | 56 MPa |
| 6 | | | | | | | |
| Comparative | 75 g | 20 g | | 5 g | FIG. 9 | ∘ | 52 MPa |
| Example 7 | | | | | | | |

In Embodiment 6, 75 g of PS, 20 g of PPE polyphenyl ether (PPE), 500 mL of THF solution, and 5 g of carbon nanomaterial were prepared and processed in accordance with the procedure of FIG. 6. The tensile strength of the resulting resin-molded article was 56 MPa.

In Comparative Example 7, 75 g of PS, 20 g of PPE, and 5 g of carbon nanomaterial were prepared and processed in accordance with the procedure of FIG. 9. The tensile strength of the resulting resin-molded article was 52 MPa.

Embodiment 6 had about an 8% higher tensile strength than that of Comparative Example 7 using the calculation 56 MPa/52 MPa=1.077.

According to the present invention, strength can thus be increased even when a resin material that is soluble in THF solvent is combined with a resin that is insoluble in the solvent.

The experimental examples have been omitted, but similar results were able to be confirmed even when the resin material was polymethyl methacrylate resin.

In ST45 of FIG. 5, mechanical stirring was performed for 2 days. However, it is possible to change the ultrasonic stirring to 1 to 2 days because a reduction in strength was not observed in PS in comparison with PC.

An experiment was performed in relation to the additive quantity of carbon nanomaterials, and the details will be described next.

TABLE 4

| Experi-ment No. | Material P̅C̅ T̅H̅F̅ C̅N̅F̅ | ProcessFlow | $\frac{CNF}{PC + CNF}$ | TensileStrength |
|---|---|---|---|---|
| Experi- | 70 g | | 0 | 59.2 MPa |
| ment 1 | | | | |
| Experi- | 66.5 g 500 mL 3.5 g | FIG. 2 | 5% | 76.0 MPa |
| ment 2 | | | | |
| Experi- | 63 g 500 mL 7 g | FIG. 2 | 10% | 80.0 MPa |
| ment 3 | | | | |
| Experi- | 56 g 500 mL 14 g | FIG. 2 | 20% | 81.3 MPa |
| ment 4 | | | | |

In Experiment 1, a resin-molded article was manufactured for comparison by injection molding a polycarbonate (PC) material to which carbon nanomaterial had not been added. The tensile strength of the resin-molded article was 59.2 MPa.

In Experiment 2, 66.5 g of PC, 500 mL of THF solution, and 3.5 g of ungraphitized carbon nanomaterial were prepared and processed in accordance with the procedure of FIG. 2. The percentage of added ungraphitized carbon nanomaterial was 5%. The tensile strength of the resulting resin molded article was 76.0 MPa.

In Experiment 3, the percentage of added ungraphitized carbon nanomaterial was changed to 10% in contrast to Experiment 2. The tensile strength of the resulting resin molded article was 80.0 MPa.

In Experiment 4, the percentage of added ungraphitized carbon nanomaterial was changed to 20% in contrast to Experiment 2. The tensile strength of the resulting resin molded article was 81.3 MPa.

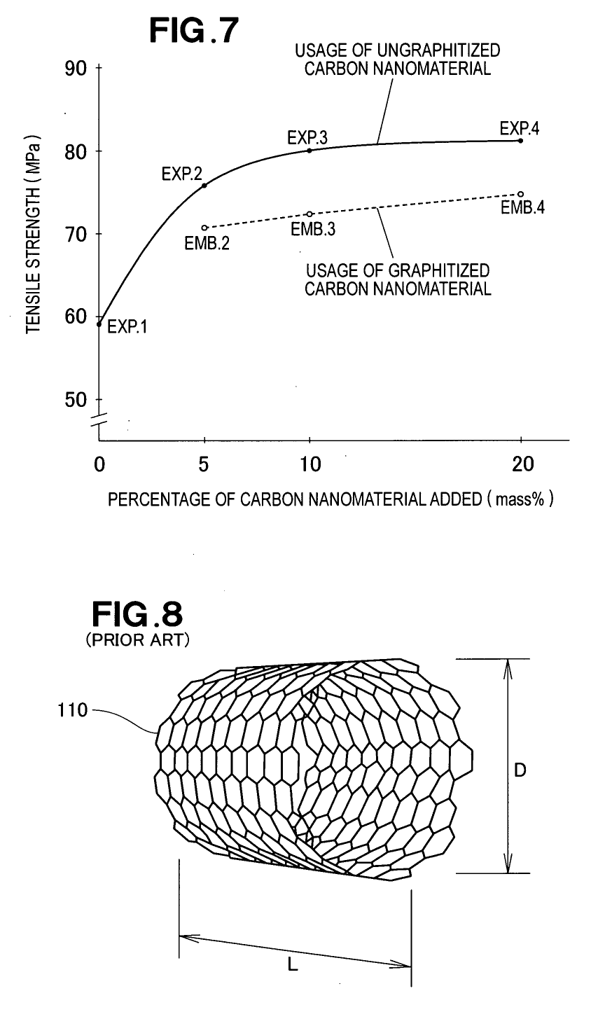

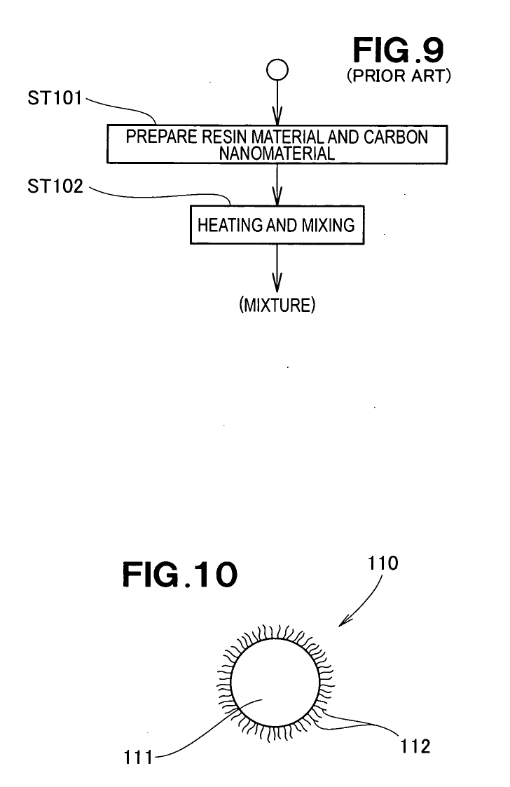

FIG. 7 is a graph showing a correlation between the tensile strength and the percentage of carbon nanomaterial added. The dotted line is a line connecting the 70.7-MPa tensile strength of Embodiment 2, the 72.3-MPa tensile strength of Embodiment 3, and the 74.8-MPa tensile strength of Embodiment 4 shown in TABLE 1. Embodiments 2 to 4 had graphitized carbon nanomaterial.

In contrast, the solid line is a curved line connecting 59.2 MPa, 76.0 MPa, 80.0 MPa, and 81.3 MPa of Experiments 1 to 4 shown in TABLE 4.

It is apparent from the graph that the embodiments in which ungraphitized carbon nanomaterial was used show an overall improvement in strength in comparison with those in which graphitized carbon nanomaterial was not used. Ungraphitized carbon nanomaterial has a surface that is rougher than graphitized carbon nanomaterial and is accordingly regarded to intertwine more readily with resin materials, with the strength being improved as a result.

Obviously, various minor changes and modifications of the present invention are possible in light of the above teaching. It is therefore to be understood that within the scope of the appended claims the invention may be practiced otherwise than as specifically described.

What is claimed is:

1. A method for manufacturing resin-coated carbon nanomaterial, comprising the steps of:
preparing an organic solvent having tetrahydrofuran as a main ingredient, a resin material dissolved in the organic solvent, a carbon nanomaterial, and water;
mixing the organic solvent and the resin material, thereby dissolving the resin material in the organic solvent and obtaining a resin dispersion solution;
adding the carbon nanomaterial to the resulting resin dispersion solution and stirring the solution in order to obtain a carbon nanomaterial/resin dispersion solution;
forming an aqueous solvent phase wherein water is added to the resulting carbon nanomaterial/resin dispersion solution and the organic solvent is converted to an aqueous phase; and
drying an aqueous phase solution so as to remove the organic solvent in order to obtain a resin-coated carbon nanomaterial.

2. The manufacturing method of claim 1, wherein the stirring in the stirring step is mechanical stirring.

3. The manufacturing method of claim 1, wherein the resin material includes at least one variety selected from polycarbonate resin, polystyrene resin, and polymethyl methacrylate resin.

4. The manufacturing method of claim 1, wherein a ratio of the carbon nanomaterial to the carbon nanomaterial coated with the resin is 3 to 20 mass %.

5. The manufacturing method of claim 1, wherein the carbon nanomaterial is an ungraphitized carbon nanomaterial that has not been subjected to a graphitization treatment.

6. A method for manufacturing a carbon nanocomposite resin molded article, comprising the steps of:
preparing an organic solvent having tetrahydrofuran as a main ingredient, a resin material dissolved in the organic solvent, a carbon nanomaterial, and water;
mixing the organic solvent and the resin material, thereby dissolving the resin material in the organic solvent and obtaining a resin dispersion solution;
adding the carbon nanomaterial to the resulting resin dispersion solution and stirring the solution in order to obtain a carbon nanomaterial/resin dispersion solution;
forming an aqueous solvent phase wherein water is added to the resulting carbon nanomaterial/resin dispersion solution and the organic solvent is converted to an aqueous phase;
drying the aqueous phase solution so as to remove the organic solvent in order to obtain a resin-coated carbon nanomaterial;
preparing a carbon nanomaterial coated with the resulting resin; and
injection-molding the resin-coated carbon nanomaterial, thereby obtaining a carbon nanocomposite resin molded article.

7. The manufacturing method of claim 6, wherein the stirring in the stirring step is mechanical stirring.

8. The manufacturing method of claim 6, wherein the resin material includes at least one variety selected from polycarbonate resin, polystyrene resin, and polymethyl methacrylate resin.

9. The manufacturing method of claim 6, wherein a ratio of the carbon nanomaterial to the carbon nanomaterial coated with the resin is 3 to 20 mass %.

10. The manufacturing method of claim 6, wherein the carbon nanomaterial is an ungraphitized carbon nanomaterial that has not been subjected to a graphitization treatment.
